(19) United States
(12) Patent Application Publication
(10) Pub. No.: US 2010/0097780 A1
(43) Pub. Date: Apr. 22, 2010

(54) Refrigerated led illumination system

(76) Inventors: John Bryan Beatenbough, Anderson, SC (US); Ryan Edward Haley, Hartwell, GA (US)

Correspondence Address: MCNAIR LAW FIRM, P.A., P.O. BOX 447, GREENVILLE, SC, 29602-0447, US

(21) Appl. No.: 12/313,333

(22) Filed: Nov. 19, 2008

Related U.S. Application Data
(60) Provisional application No. 61/107,203, filed on Oct. 21, 2008.

(51) Int. Cl. F25D 27/00; H01J 9/24

(52) U.S. Cl. 362/92; 445/23

(57) ABSTRACT

A self-contained LED lighting assembly for use in a refrigerated cabinet contains a plurality of LEDs mounted upon a substrate, each using a refractive lens designed to evenly disperse the light emitted from each LED into a flat, wide pattern suitable for lighting the contents of the cabinet. Heat is effectively removed from each LED and transported to an interior air space within the LED lighting assembly housing. The system is designed to replace current lighting systems and is sized fit within the space provided for current lighting systems, without the need for substantial modification, cutting, or removal of the current lighting systems. The assembly may be composed of individual LED lighting modules wired end-to-end to provide a desired length of strip lighting. Upon complete installation, the system provides the same or better lighting using only a fraction of the power required by the system replaced.

This application claims priority from Provisional Application 61/107,203 filed Oct. 21, 2008.

### BACKGROUND OF THE INVENTION

The invention relates to a refrigerated cabinet lighting system and, more particularly, to a self-contained LED lighting assembly for use within a refrigerated cabinet. The system is designed to replace current lighting systems and is sized fit within the space provided for current lighting systems without the need for substantial modification, cutting, or removal. Upon complete installation, the system provides the same or better lighting using only a fraction of the power required by the system replaced. The system further provides for improved startup and switching capabilities, thereby facilitating zoned and motion-detection lighting schemes that further reduce electrical power consumption.

Lighting systems for refrigerated cabinets have changed a great deal since the inception of the light bulb. Early systems used incandescent bulbs, which required vastly more energy and produced far greater heat. Still later systems used florescent tubes that provided additional light using far less power and producing far less heat output. For example, a typical florescent lighting system used inside refrigerated cabinets includes a five-foot long florescent tube consuming approximately 60 watts of power, whereas the prior incandescents used twice that amount. At least one of these tubes is generally placed inside the cabinet door frame between refrigerated doors. Typically, many stores have anywhere from 10-200 doors, thereby requiring from ten to two hundred 60 watt florescent tubes for lighting. Although these florescent tubes provide ample light and use far less electricity than incandescent bulbs, these florescent bulbs nevertheless consume a great deal of power, especially given the fact that they traditionally run 100% of the time the store is open to the public.

By contrast, LED lighting systems traditionally use from one-fourth to one-tenth the electrical power required by florescent lighting. Early LED lighting systems, such as the system set forth in U.S. Pat. No. 7,121,675 to Ter-Hovhannisian, use LED lighting systems designed to replace previous generation refrigerated cabinet lighting systems. The Ter-Hovhannisian system presented many advantages over prior art florescent systems but required a complete replacement of the prior lighting system to be effective. In other words, Ter-Hovhannisian's system requires that the housing, bulb, ballast, power supply, etc. previously installed for the refrigerated cabinet be completely removed before Ter-Hovhannisian's system can be installed. Even after installation, Ter-Hovhannisian's lighting system suffered from additional problems. For example, the LED lights generally provided illumination in only a small directional beam directly in front of each LED, thereby leaving the side-to-side items largely unilluminated.

Still other systems, such as U.S. Patent Application Pub. No. 2004/0012959 to Robertson et al., present an improved solution that nevertheless continues to suffer from directional illumination problems. The system set forth in Robertson et al. proposes to fill a florescent tube with a plurality of LEDs so that a direct fluorescent tube replacement will function with LEDs. The primary problem with this approach is that far more LEDs are required to provide sufficient illumination in a small omni-directional tube than would otherwise be required to provide uni-directional illumination in other devices.

What is needed is an LED illumination system that overcomes the present limitations of the prior art by providing a direct replacement LED lighting assembly designed to fit within the confines of a standard five foot florescent tube space limitations. What is also needed is an LED lighting system that is self-contained, requiring no removal of the florescent lighting system's ballast, housing, and power supply. These items are now considered hazardous waste and disposal is very costly; therefore, leaving these items in place is a preferable solution to removal. And finally, what is also needed is an LED lighting system that uses a minimum amount of LEDs, yet provides light in a sufficiently wide dispersion pattern so as to evenly and completely light the contents of a refrigerated cabinet both front-to-back and side-to-side.

Accordingly, an object of the present invention is to provide an LED lighting system for use in a refrigerated cabinet that may be installed directly within the space previously occupied by a standard florescent lighting tube. Another object of the present invention is to provide that LED lighting system using a small amount of LEDs evenly spaced and strategically utilized to provide lighting for the entire interior of a refrigerated cabinet. Still another object of the present invention is to provide a specially designed refractive lens that is placed directly over each LED to evenly and completely disburse all the light from the LED in an even pattern throughout the interior of the refrigerated cabinet. Other objects and benefits of the present invention will become apparent from the detailed description when taken in conjunction with the drawings provided.

### SUMMARY OF THE INVENTION

The foregoing objects have been achieved in the present invention, whereby the present invention overcomes the above-identified and other deficiencies in conventional LED lighting systems by providing a self-contained LED lighting system capable of being placed directly in the space previously occupied by florescent tubes within a refrigerated cabinet. The apparatus disclosed herein provides for direct replacement of florescent lighting and incandescent lighting by providing a correctly sized LED lighting assembly designed for direct installation in place of previous lighting systems. The apparatus provides numerous advantages over the prior art, including the fact that most of the components of current lighting systems can be left in place during installation. For example, all the components in a fluorescent lighting system except the bulb may remain in place, thereby avoiding the need for hazardous waste disposal generally required for disposal of the ballast. The system also provides a specially designed refractive lens that is customizable for various types of LEDs. When installed, the lens provides a wide pattern of light dispersion more suitable for lighting within a refrigerated cabinet. The lens also provides greater heat dispersion and removal by completely encapsulating each LED.

The lighting apparatus is sized to fit in the space previously occupied by the bulb being replaced. No cutting of the previous housing, wiring etc. is requiring to install the lighting apparatus. When installed, the LED illumination system provides the same or greater light output as the bulb it replaces in a warm or acceptable white color, something that is only possible very recently due to upgrades in LED technology. The apparatus also provides the light using far less power than the bulb it replaces. Unlike prior art systems, the lighting apparatus is fully enclosed, with all components, including the power supply, housed within the apparatus.

The invention comprises a plurality of LEDs carried on a rigid substrate. Underlying the substrate, a heat sink system is provided using a thin layer of metal on the bottom of the substrate. Immediately surrounding each of the plurality of LEDs is a plurality of metal-lined heat sink holes that are in metal to metal contact with the thin layer of metal on the bottom of the substrate. When the specially designed lens is placed over the LED, the outer circumference of the lens contacts the substrate to uniformly space the lenses above each LED for uniform illumination. The heat sink system operates to channel the heat produced by each LED downwards through each of the plurality of heat sink holes into the open channel provided below the rigid substrate. Heat is therefore absorbed in at least two ways: first, by air convection from the space surrounding the LED to the space below the LED; second, by metal-to-metal conduction from the metal line holes to the metal layer on the bottom of the rigid substrate.

The invention also comprises a constant-current power supply rather than a mere constant-voltage or regulated power supply as seen in prior art systems. Constant-current power supplies better regulate power consumption and improve long-term reliability of the LEDs. The power supply is mounted directly below the rigid substrate and within a C-channel housing designed to carry the rigid substrate. As such, the C-channel, rigid substrate, LEDs, and lenses are all provided in an integrated and self-contained apparatus.

The invention further comprises a specially designed lens directly over-laying each LED on the substrate. The lens is preferably clear and uncoated, generally a polycarbonate or other form of clear plastic. The lens is designed to evenly disburse light from each of the LEDs in a flat, wide pattern in front of and lateral to each LED. This allows the LED to deliver light evenly over a nearly 180° arch in front of each LED, rather than delivering nearly all of the light in a beam less than 90° wide directly in front of the LED as provided by prior art systems. The lens also contacts and encapsulates each LED to improve lighting dispersion and heat removal away from each LED and into the C-channel below. An embodiment of the lens is provided, wherein five individual lenses are formed by injection molding into a substantially flat and rigid assembly designed to fit directly over a similarly sized flat and rigid substrate. To support exact placement of each lens directly above each of the LEDs, a placement nipple is provided. The placement nipple is designed to protrude into direct fitting holes within each of the rigid substrates. And finally, the lens is specially designed to operate with a variety of LEDs based on size, color, temperature, power, and shape. In other words, each lens may be computer designed to optimize potential lighting patterns based upon the specific type of LED being used.

In a highly advantageous aspect of the invention, a modular LED strip lighting assembly may be provided in standard lengths by simply changing the number of lighting modules included in the housing. The modular assembly includes a longitudinal housing with a plurality of LED lighting modules carried end-to-end along a length of said housing. A plurality of LEDs is carried by the lighting modules and a plurality of refractive lens carried by the housing covering the LEDs for dispersing a wide angle of light from each of the LEDs. A constant current control circuit is carried by at least one of the lighting modules for delivering a generally constant electrical current to the LEDs. Advantageously, the LED lighting modules include at least one master lighting module and at least one slave lighting module associated with the master module wherein the current control circuit is carried on the master lighting module and is electrically connected to the LEDs on the master and slave lighting modules.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of an LED illumination system installed within a refrigerated cabinet, according to a preferred embodiment of the invention.

FIG. 2 is a perspective view of an LED lighting assembly, according to a preferred embodiment of the invention.

FIG. 3A is a perspective view of the various components of an LED lighting assembly broken down into individual pieces.

FIG. 3B is a perspective view of a portion of the main components of an LED lighting assembly broken down into individual pieces.

FIG. 3C is a perspective view of a portion of the main components of an LED lighting assembly fitted together.

FIG. 4A is a side view of a standard LED indicating a narrow dispersion pattern of light emitted.

FIG. 4B is a side view of the same LED with a specially designed refractive lens overlaying the LED to improve its light dispersion pattern.

FIG. 5A is a perspective view of a portion of a lens assembly indicating a specially designed lens and alignment nipple.

FIG. 5B is a bottom view of the same specially designed lens indicating the lens curvature.

FIG. 5C is a side view of the same specially designed lens further indicating the lens curvature.

FIG. 6A is a side view cut-away of a specially designed lens indicating the interior curvature and shape of the lens.

FIG. 6B is a top view of the same specially designed lens indicating the location of the individual curves within the lens.

FIG. 6C is a bottom view of the same specially designed lens further indicating the lens' curvature.

FIG. 7A is a side view of an LED mounted on a rigid substrate over-laid by a specially designed lens.

FIG. 7B is a top view of the same LED mounted on a rigid substrate and over-laid by a specially designed lens, also indicating the LED power connections, heat sink holes, and location of the lens.

FIG. 7C is a bottom view of the same LED mounted on a rigid substrate, indicating the metal-lined underbody of the rigid substrate and the metal-lined holes surrounding the LED.

FIG. 8A is a side view cut-away of an LED mounted on a rigid substrate and over-laid by a specially designed lens along with a blowup indicating the LED in close perspective.

FIG. 8B is an enlarged blowup of an LED mounted on a rigid substrate, indicating the metal lined heat sink holes and the passage of heat there through.

FIG. 9A is a top view of a specially designed lens over-laying an LED mounted on a rigid substrate and having metal-lined heat sink holes appurtenant thereto.

FIG. 9B is a cut away perspective of the same specially designed lens over-laying an LED and heat sink holes.

FIG. 10 is a graphic representation of the lighting intensity and dispersion pattern of light emitted from three common LEDs.

FIG. 11 is a bottom plan view of a modular LED lighting assembly according to the invention.

FIG. 12 is a top plan view of a modular LED lighting assembly according to the invention.

FIG. 13 is a perspective view of a modular LED lighting assembly according to the invention.

FIG. 14 is an end view of a modular LED lighting assembly according to the invention with an end plate removed.

FIG. 15 is an in end view of a modular LED lighting assembly according to the invention with end plate installed.

FIG. 16 is a schematic view of a master LED lighting module and current control circuit according to the invention.

FIG. 17 is a schematic view of a slave LED lighting module according to the invention.

FIG. 18 is an illumination and distance graphical drawing according to the invention.

### DETAILED DESCRIPTION

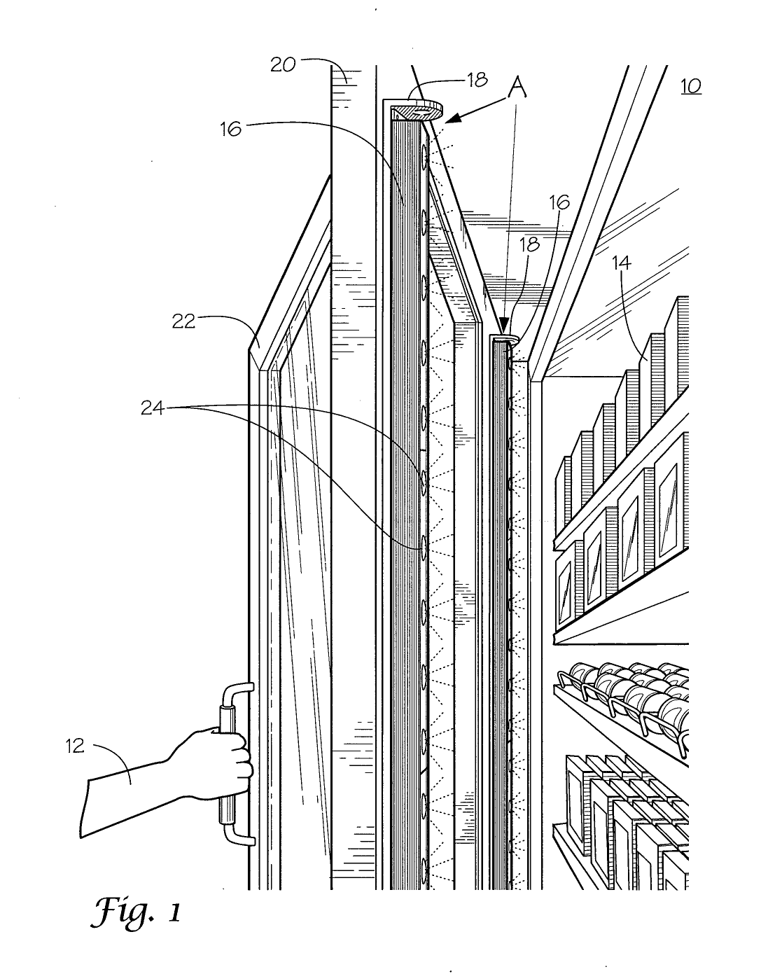

Referring now in more detail to the drawings, the invention will now be described in more detail. As can best be seen in FIG. 1, a LED lighting assembly, designated generally as A, is illustrated attached to the door of a refrigerated cabinet 10. Refrigerated products are typically stored in the cabinet behind the glass display doors for display to customers. When a customer 12 approaches cabinet 10, the contents 14 of cabinet 10 are illuminated by LED lighting assembly A. LED lighting assembly A is constructed and arranged for placement in the location where a florescent tube was formerly installed in florescent lighting assembly 18 of the cabinet. Assembly 18 is installed on door post 20 between each of the refrigerated cabinet doors 22 and is typically four feet from adjacent door posts. In the illustrated embodiment, light assembly A includes an elongated channel housing 16, a LED lighting assembly 21 carried by the housing over an open top thereof having a substrate 34 with a plurality of individual LED units 24 which include a LED 36 and a lens 46 on lens cover plate 40. Light is emitted from each of the individual LED units 24 carried upon the surface of the LED lighting assembly and refracted as indicated to provide an evenly disbursed and desirable light pattern for uniform illumination of the interior of refrigerated cabinet 10. Typically, the door 22 of refrigerated cabinet 10 is lined with glass so that customers 12 can view the contents 14 of refrigerated cabinet 10 prior to opening the door 22. A plurality of LED units 24 is generally necessary to provide sufficient lighting to uniformly illuminate the interior of refrigerated cabinet 10. That plurality of LED units 24 is configured in the preferred embodiment of FIG. 1 within C-channel housing 16.

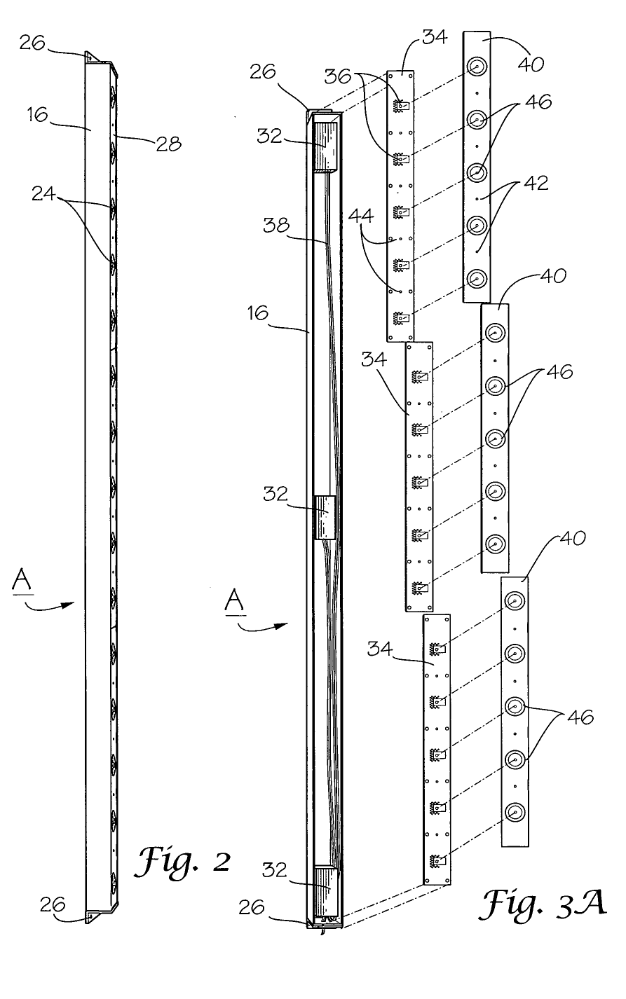

Referring now to FIG. 2, a preferred embodiment of LED lighting assembly A is illustrated. Mounting bracket 26 is used to install the lighting assembly into the space formerly occupied by a florescent lighting bulb, such as that used on florescent lighting assembly 18 of FIG. 1. In the preferred embodiment of FIG. 2, fifteen individual LED units 24 are used to produce sufficient illumination to uniformly light the interior of a cabinet such as refrigerated cabinet 10. Lens plate 40 includes a rigid substrate 28 mounted in C-channel housing 16.

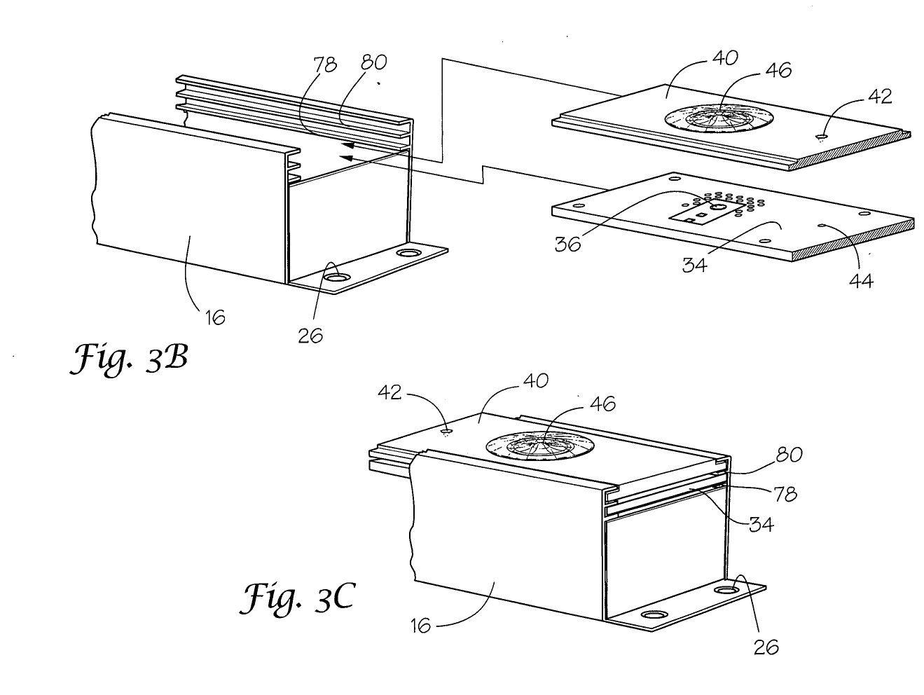

If LED lighting assembly A is disassembled into its main component parts, as indicated by the embodiment of FIG. 3A, one notes that the LEDs and lenses are preferably mounted in three sections of five each. Within C-channel housing 16, three individual constant current supplies 32 are provided to power each section of five LEDs 36 mounted on the three rigid substrates 34. C-channel housing 16 contains two grooves on each side of its outer most edge (as shown in FIG. 3B) for receiving each of the three rigid substrates 34. When installed, the rigid substrates rest near the surface of C-channel housing 16. The combination encloses current supplies 32 and conductors 38 within C-channel housing 16. Power is provided to each of the three LED sections 34 by constant current power supplies 32, which are wired together in parallel by conductors 38 beneath rigid substrates 34 and lens plates 40.

As shown in FIG. 3B, rigid substrate 34 is designed to slide into lower groove 78 of C-channel housing 16. Likewise, lens plate 40 is designed to slide into upper groove 80 so that it rests directly above and in contact with rigid substrate 34. When installed, as indicated by FIG. 3C, lens plate 40 rests directly upon rigid substrate 34. The combination of rigid substrate 34 and mounting bracket 26 act together to enclose the air space within C-channel housing 16.

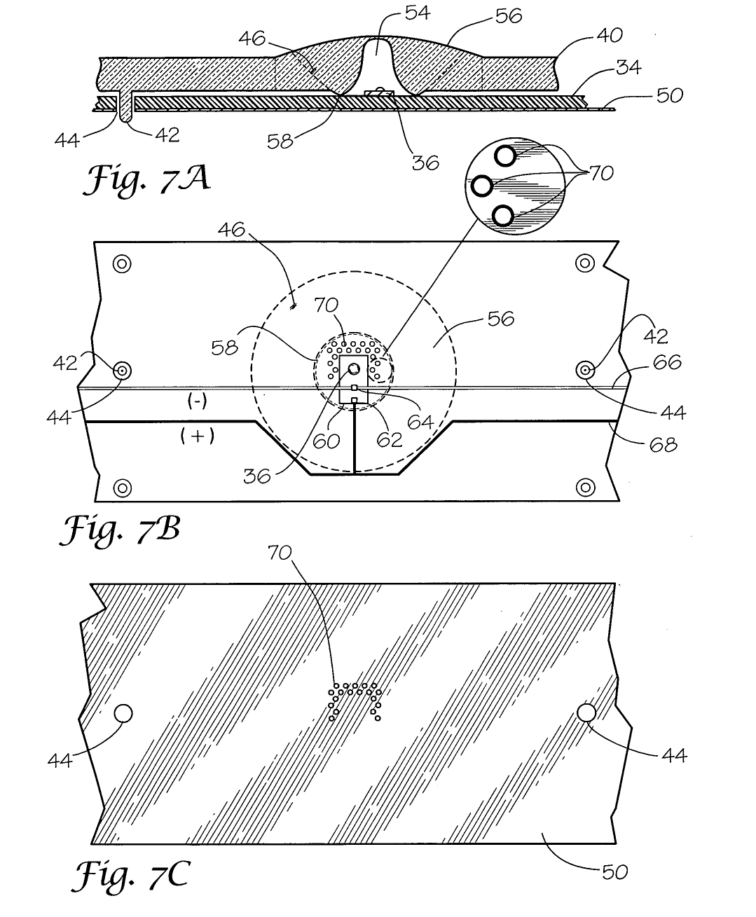

Once each of the rigid substrates 34 is installed in C-channel housing 16, each of the three groups of lens plates 40 are affixed thereto directly above each of the three corresponding rigid substrates 34 according to placement and fitting of alignment nipples 42. Both rigid substrates 34 and lens plates 40 are held in place by flexible compression of C-channel 16 within lower groove 78 and upper groove 80, respectively. Each of the lens plates 40 are properly aligned by alignment nipples 42, which project into alignment nipple receiving holes 44 found in equidistant locations along each of rigid substrates 34. In other words, alignment is made possible by alignment nipples 42, which project downward and into alignment nipple receiving holes 44 so that the respective lateral positions of rigid substrate 34 and lens plate 40 remain fixed. Once installed, each of the lenses 46 directly overlays LEDs 36 to provide for proper dispersion of the light emanating from LEDs 36 and to provide for proper removal of the heat generated by LEDs 36 as discussed with reference to FIG. 7.

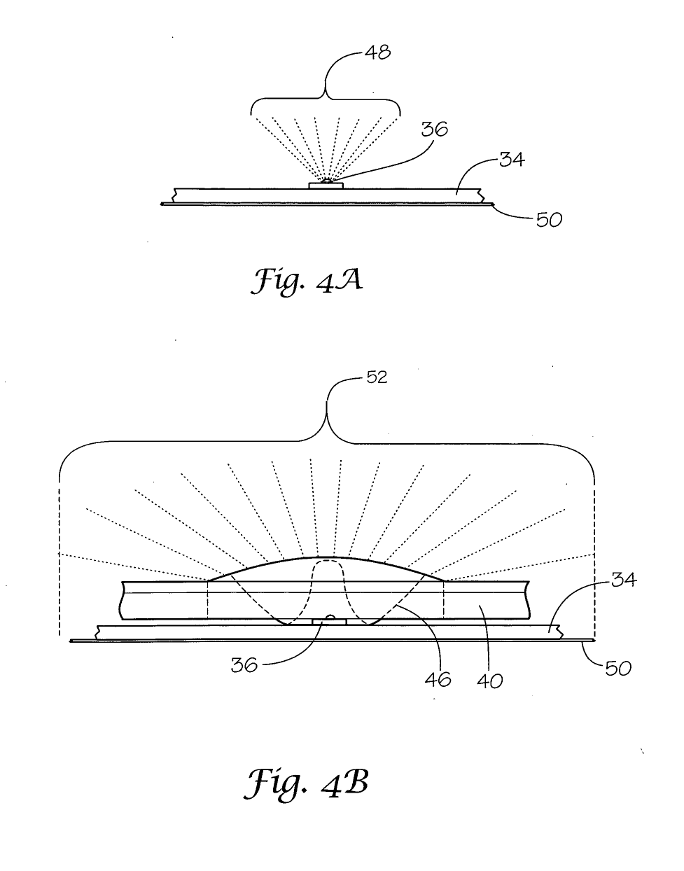

Referring now to FIG. 4A, LED 36 is shown mounted upon rigid substrate 34. Without lens 46 over-laying LED 36, the dispersion of light from LED 36 generally ranges no greater than 90°, as indicated by angle 48. One of the primary advantages of the invention is improved light dispersion provided by lens 46. As shown in FIG. 4A, the range of light dispersion normally provided by an unaided LED is very narrow, rarely greater than 90°.

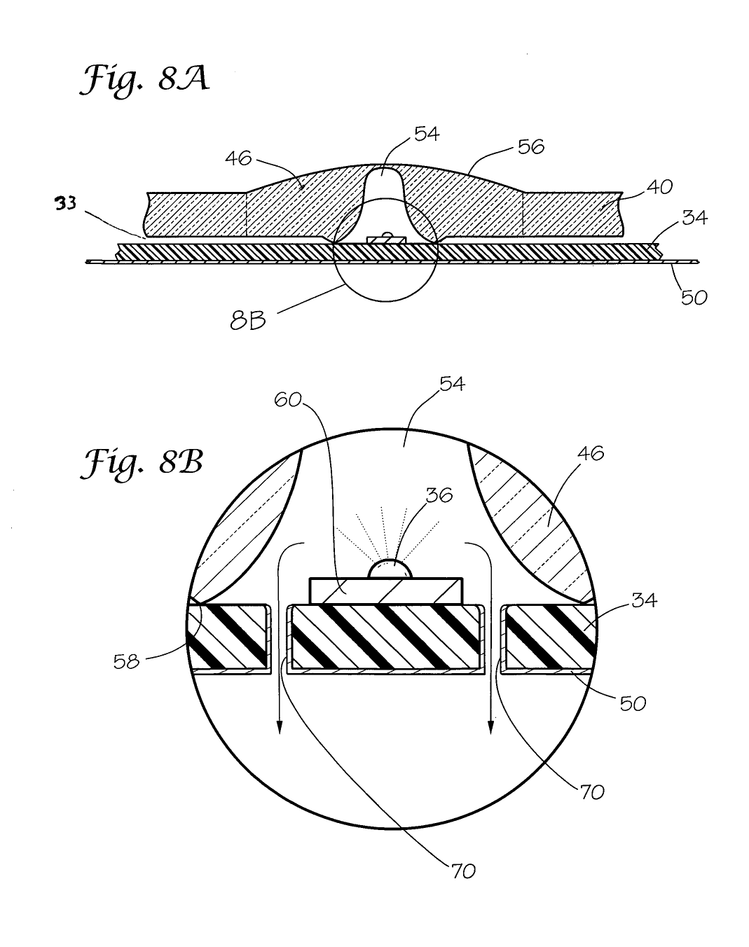

In addition, a thin metal layer 50 is provided upon the bottom of rigid substrate 34 for heat removal as discussed further with reference to FIGS. 7 & 8. Metal layer 50 runs the length of the underside of rigid substrate 34. When in use, LED 36 generates heat. That heat is channeled by lens 46 and heat sink holes 70, as more fully discussed with reference to FIG. 8B.

FIG. 4B indicates the improved light dispersion according to an embodiment of the invention using lens 46. Light emanating from LED 36 is refracted using lens 46 to produce a much wider and nearly 180° angle 52. This wider angle dispersion is possible because the specially designed lens 46 optimizes and refracts light emanating from LED 36 into a substantially flat and wide pattern more suitable for lighting the contents of a wider, flatter area such as the interior of a refrigerated cabinet 10. Because the contents 14 of a refrigerated cabinet 10 typically rest both in front of and lateral to the light source on door post 20, the light source must be able to project a wide angle pattern of light, such as angle 52. In other words, narrow angle 48 would be unsatisfactory for lighting a refrigerated cabinet 10 because the light emitted would only manage to light the contents 14 directly in front of LED 36. Other cabinet contents 14 that rest lateral to (on each side) LED 36 would receive little or no light from the uncorrected LED 36 shown in FIG. 4A. By contrast, the specially designed lens 46 of FIG. 4B refracts the light emitted from LED 36 so that the light projected from the surface of lens 46 is uniform in a wide angle pattern sufficient to light all the contents 14 of refrigerated cabinet 10.

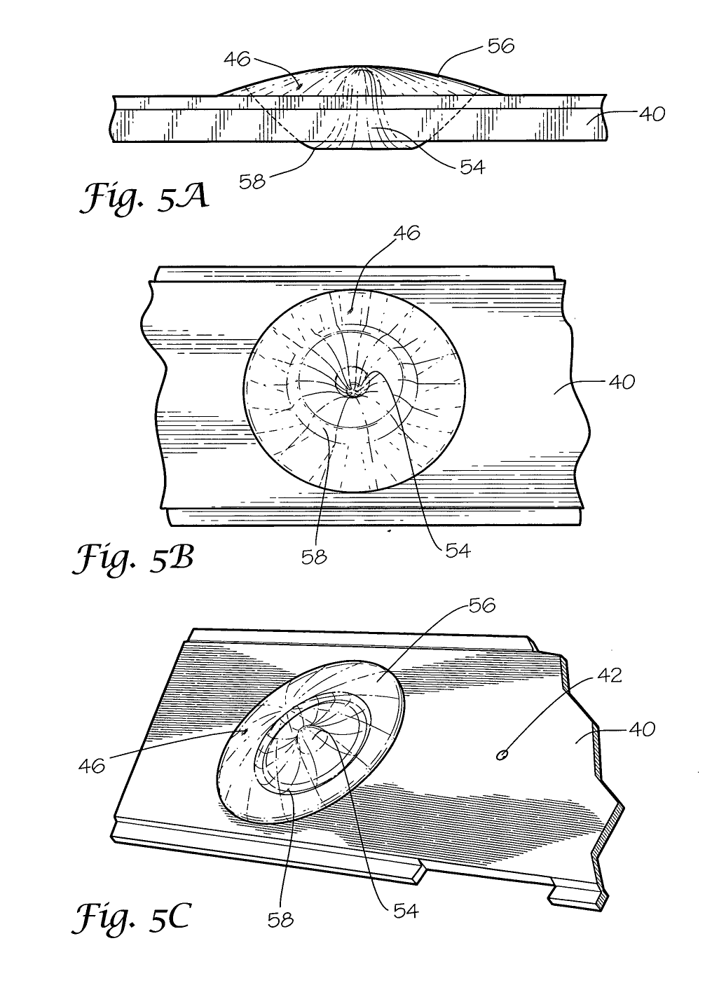

FIG. 5A illustrates a side view of lens 46 according to an embodiment of the invention. The interior dome 54 that resides directly above the LED is specifically designed and matched to individual types of LEDs. Interior dome 54 works with exterior dome 56 in combination to provide the widest and most desirable dispersion of light capable of being produced with the chosen individual LED. In other words, interior dome 54 and exterior dome 56 are specially designed to optimize light dispersion given a particular LED's optical characteristics. In a preferred embodiment, domes 54 and 56 are specially shaped according to a particular LED's shape, color, lumen output, etc., using any of a number of commercially available software applications, such as Code V® or LightTools®.

In accordance with the above, an all-refractive lens was designed for the refrigerator strip light application. The design achieves an efficiency of 90%, effectively illuminating a 60 inch tall by 28 inch wide product surface area from a range of 4 inches beyond the face of the lens. The design achieved plus or minus 25% luminance uniformity, in spite of the extreme aspect ratio presented by the product surface. The front face of the lens is a smooth, low-profile nearly spherical surface that can be easily cleaned. The lens uses clear PMMA (acrylic) material, and can be produced using compression molding techniques.

In this way, lens 46 can also be specially designed to suit a particular application. For example, lens 46 could be adapted to provide lighting in a non-refrigerated environment where, heat output is less of a concern. In such a case, a more powerful LED could be used to provide greater light intensity and lens 46 could be shaped to project that light in any desired pattern, angle, or direction as needed. Overhead lighting in small or large rooms is one likely possibility because lens 46 could easily be adapted for wider or narrower angles as needed given ceiling height. The same is true for landscape lighting and many other applications, where the primary variable is the pattern of light needed. Given the invention's adaptability to many potential lighting patterns, lens 46 is easily shaped to provide the intensity and coverage of light needed.

FIG. 5A illustrates an embodiment adapted to a refrigerated application for several reasons. The lower-most portion of dome 54 contacts the rigid substrate at lower edge 58 so as to surround the LED, and provide a defined spacing between the lens and LED. In this way, lower edge 58 encapsulates the LED. Optical efficiency is optimized by forcing all of the light emitted from the LED to travel up from lower edge 54 through interior dome 58 out through exterior dome 56. None of the light escapes, therefore, from between lower edge 54 and rigid substrate 34. As discussed more fully with reference to FIG. 8B, the heated air is then forced downward by the heat sink into the open cavity within C-channel housing 16.

As illustrated in FIG. 5B, lower edge 58 is circular and designed to protrude slightly below lens plate 40 so as to allow lens plate 40 to rest upon the rigid substrate 34 without contacting the rigid substrate 34 in other locations. FIG. 5B further illustrates the interior dome 54 as it appears from a bottom view.

FIG. 5C illustrates a top prospective view of the lens, wherein exterior dome 56 is clearly visible as a hemispherical protrusion from lens plate 40. The interior dome 54 is also visible with respect to the remainder of the lens. And, finally, the ring of lower edge 58 is also visible from the surface as indicated.

Alignment nipple 42 is also indicated as it would appear on a preferred embodiment of the invention. Alignment nipple 42 protrudes downward with sufficient length to insert into a corresponding alignment receiving hole in rigid substrate 34, whereby lens plate 40 is precisely placed to position each lens 46 directly above each LED.

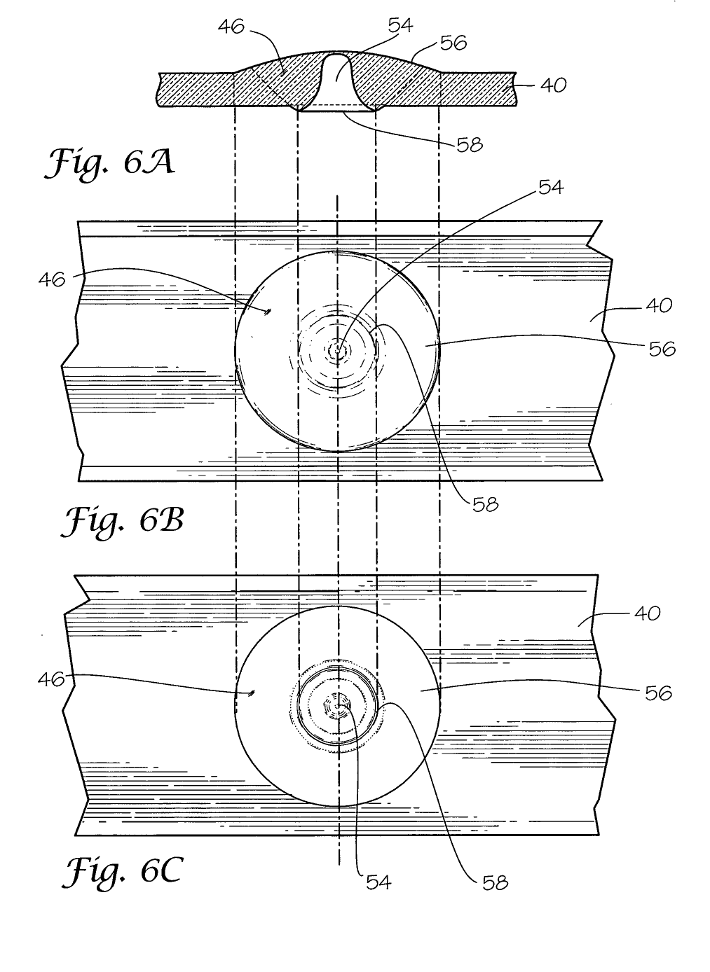

FIG. 6A illustrates a side view cutaway of lens 46. Interior dome 54 is shown as a substantially bell-shaped interior hollow space that resides directly above the LED. Exterior dome 56 is illustrated as a hemispherical protrusion directly above interior dome 54. Each of these two domes work together to maximize the light dispersion from LED 36. Again, lower edge 58 of lens 46 is also indicated.

FIG. 6B illustrates the same lens 46 from above. Downward projecting lines from FIG. 6A, to 6B, to 6C, indicate the relative positions of each particular section of lens 46 as the lens is rotated from side view in FIG. 6A, to top view in 6B, to bottom view in FIG. 6C. The circular rings of interior dome 54 remain visible through the surface of exterior dome 56 along with lower edge 58. As the lens is rotated 180° and shown from a bottom view in FIG. 6C, each of these circular rings remain visible.

Referring now to FIG. 7A, a side view cutaway of lens 46 mounted directly above LED 36 is illustrated, according to an embodiment of the invention. As shown, interior dome 54 resides directly above LED 36 so that a substantially bell-shaped interior portion is provided in the air space directly above LED 36. As the light emanates from LED 36 and projects upwards into interior dome 54, that light is refracted through a combination of interior dome 54 and exterior dome 56 to produce a very wide angle of light dispersion.

Alignment nipple 42 is also indicated as it projects through alignment nipple receiving hole 44. Each lens plate 40 includes two or more alignment nipples 42 that are inserted into alignment nipple receiving holes 44 to ensure proper alignment of each lens 46 directly above each LED 36.

When the lens plate 40 and rigid substrate 34 are rotated 90° to view both from above as indicated in FIG. 7B, all of the components in this embodiment of the invention are visible. LED 36 is shown at the center of FIG. 7B as powered by positive conductor 68 and negative conductor 66, which connect at connection points 64 and 62, respectively. Both conductors are preferably stamped onto the surface of rigid substrate 34. The LED housing 60 is now visible also. Lower edge 58 of lens 46 surrounds LED 36, its housing 60, and a plurality of heat sink holes 70. If this same embodiment is rotated 180° so as to be viewed from its bottom as illustrated in FIG. 7C, the only portions remaining visible are the thin metal assembly 50, residing along the bottom of substrate 34, the plurality of heat sink holes 70 surrounding LED 36, and alignment nipple receiving holes 44.

FIG. 8A continues this line of drawings with a side-view cutaway of lens 46 mounted above substrate 34. Blowup 8B is indicated in FIG. 8B, to more fully illustrate heat sink holes 70 and their operation. As illustrated in FIG. 8B, lower edge 58 of lens 46 contacts rigid substrate 34, thereby surrounding the area in the immediate vicinity of LED 36 and the plurality of heat sink holes 70. Moreover, LED 36 and heat sink holes 70 are fully encapsulated within a confined air space underneath bell-shaped interior dome 54. In this way, the heat emanating from LED 36 is forced downward through the plurality of heat sink holes 70. Heat transfer occurs through heat sink holes 70 in at least two ways. First, heat is conducted through the metal lining inside each of the plurality of heat sink holes 70, because the metal lining inside each hole 70 is in metal-to-metal contact with the metal lining 50 on the bottom of rigid substrate 34. Second, the air within the interior dome 54 is forced downward through convection and expansion of the air above LED 36, because heat sink holes 70 provide the only means of escape for the heated air. In this way, heat generated by operation of LED 36 travels downward to heat sink 50, where that heat dissipates along the length of heat sink 50's surface into the open cavity within C-channel housing 16.

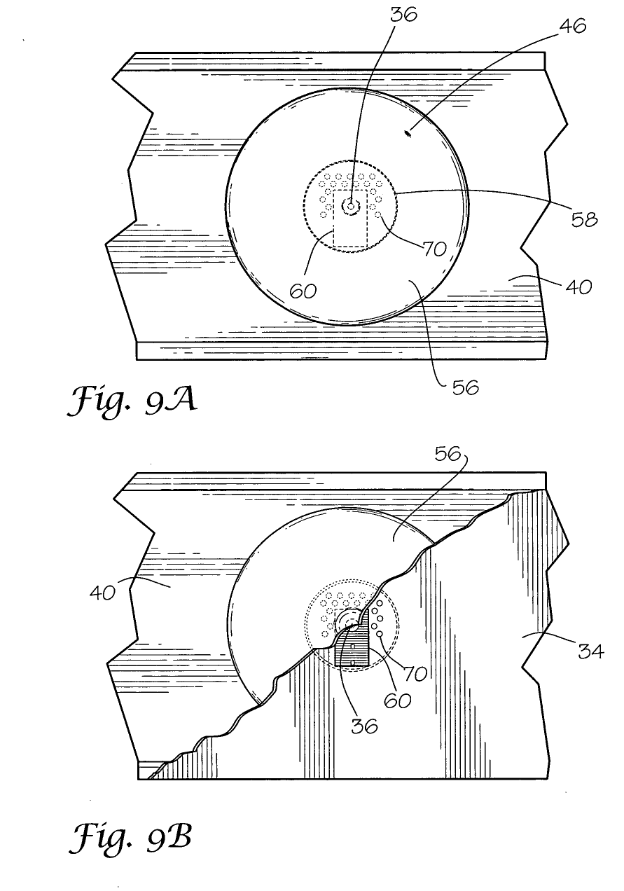

Referring now to FIG. 9A, a top view perspective of a lens overlaying an LED is illustrated. As shown, lower edge 58 of lens 46 completely surrounds LED 36 and LED housing 60, and contacts substrate 34 for defined spacing and uniform illumination (FIGS. 8A). If a portion of the lens covering is removed as shown in cutaway FIG. 9B, the LED housing 60 and LED 36 are plainly visible along with the plurality of heat sink holes 70.

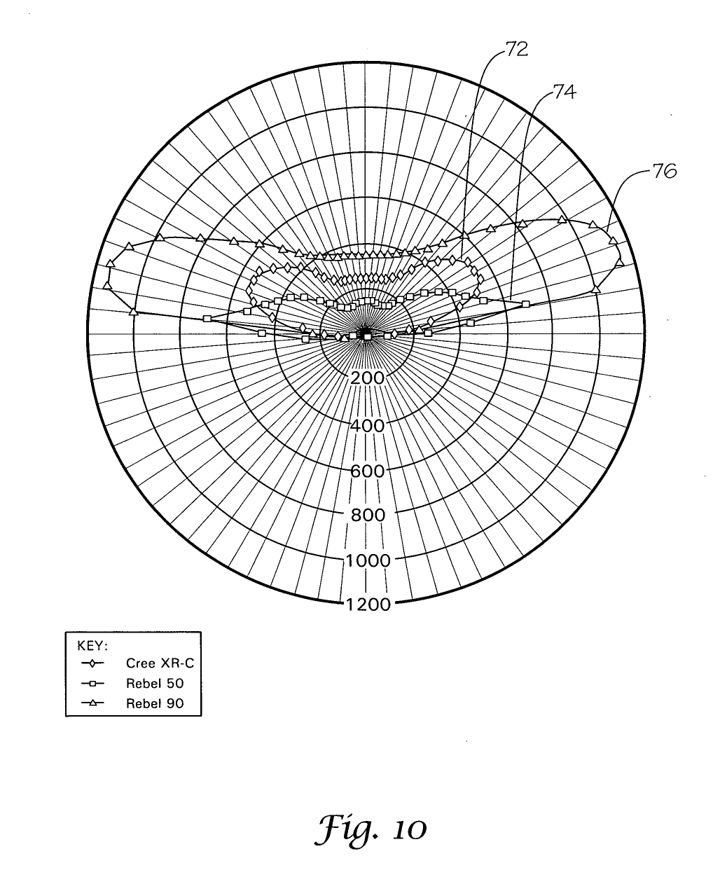

FIG. 10 is a graphical representation of the light emissions from three common types of LEDs. As indicated, the graph of FIG. 10 contains outwardly projecting concentric rings, each of which indicates successive one foot distances away from the LED shown in the center. Each of those rings also illustrates a successive 200 lux increase in lighting intensity. And, finally, the rings also show directional orientation of the light emanating from the LED. In other words, the graphical shapes indicated provide a close approximation of the lighting pattern observed projecting outward from the LEDs in actual use with an embodiment of lens 46 over-laying each LED.

A Cree XR-C LED is indicated in the diamond-shaped pattern, whereby the light projects in a substantially flat, wide pattern with a maximum of approximately 550 lux at a distance of 2½ feet from the Cree XR-C LED. The Rebel 50 LED shown in the square pattern has a very flat emanating light beam that maximizes at approximately 700 lux at approximately 3½ feet lateral to the LED, whereas only approximately 150 lux is observed directly in front of the Rebel 50 LED from less than a foot away. The Rebel 90 LED is similarly shown in a triangular pattern. The Rebel 90 LED is a recent creation that provides 90 lumens per watt, yet still provides an acceptably warm white color output. When an embodiment of the invention is applied, the Rebel 90 emits almost 1200 lux at nearly 6 feet lateral to the center of the LED and as much as 400 lux directly in front of the LED. One can see from these graphical representations that the preferred embodiment lens flattens and widens the angle of dispersion of each LED so as to provide a substantially uniform and desirable lighting pattern not only from front-to-back but also from side-to-side, thereby making the light pattern ideal for interior lighting of a refrigerated cabinet 10 as indicated in FIG. 1. Without application of lens 46, each of the graphs in FIG. 10 would show full intensity of light directly in front of each LED with virtually no intensity side-to-side.

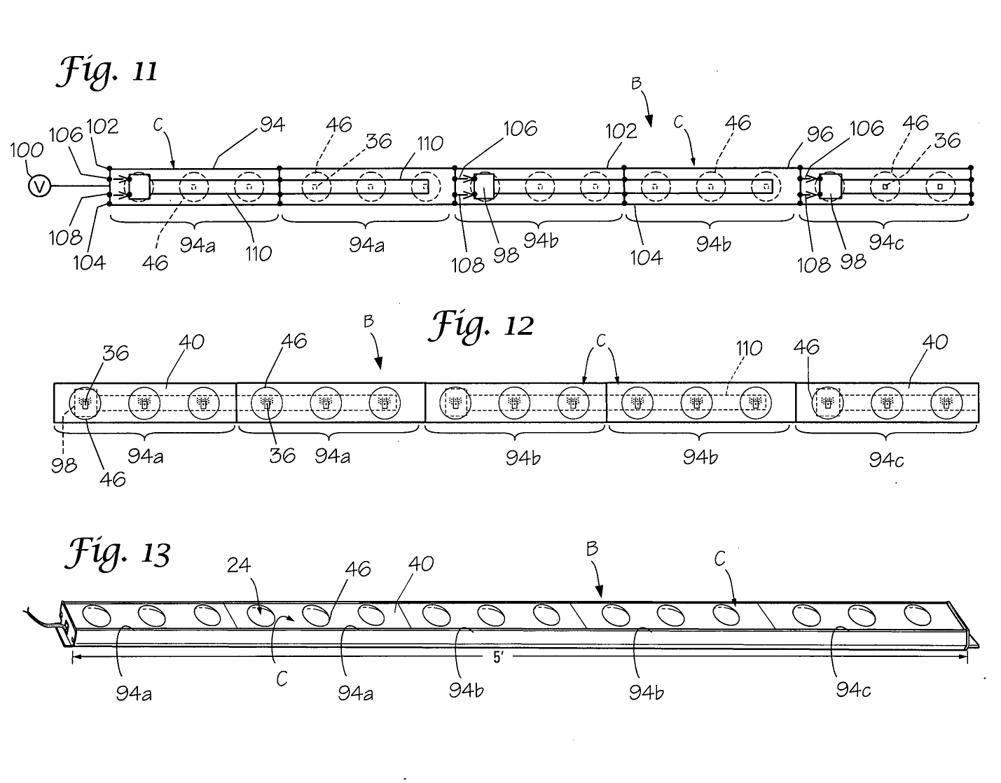

Referring now to FIGS. 11 through 18, an alternate embodiment of the invention is disclosed in a modular, low profile assembly. As can best be seen in FIG. 11, a modular LED lighting assembly, designated generally as B, is illustrated which is attached to the door of a refrigerated cabinet the same as the LED lighting assembly A. The LED lighting assembly B has many of essentially the same elements as found in lighting assembly A, and those elements will be given like reference numerals. The LED lighting assembly B has the advantages of a lower profile, low voltage, and a modular lighting assembly configuration. The low profile allows a greater perpendicular distance, P, between the light source and the product shelf and increase illumination of the food product in the refrigerated cabinet. The low voltage arrangement facilitates the low profile by removing the power supply from the lighting assembly, removes heat from the assembly, provides increased reliability, and results in Class 2 voltage classification for safety and UL certification.

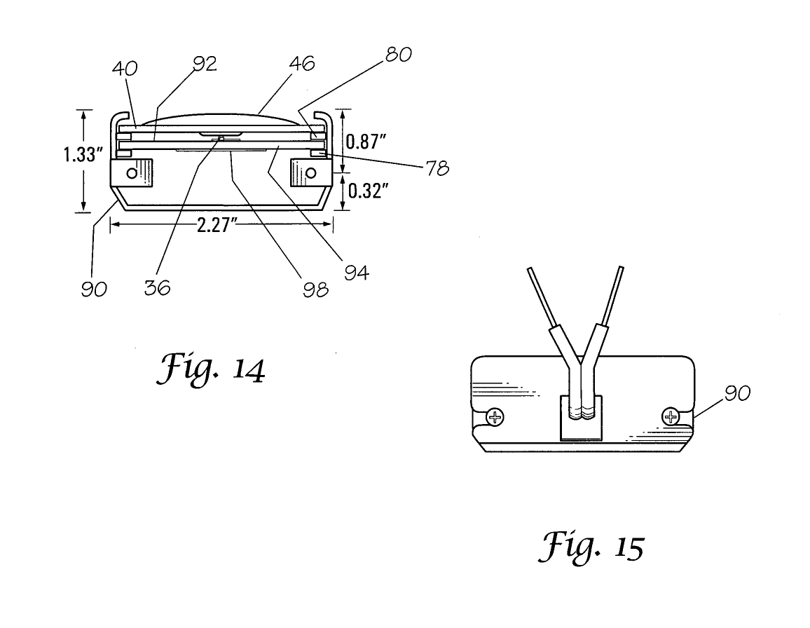

Referring to FIG. 14, it can be seen that housing 90 has a low profile defined by a depth of approximately 1.33 inches in the illustrated embodiment. The housing has a width of approximately 2.27 inches and a length of approximately 5.0 feet. The depth profile of housing 16 in FIGS. 3B and 3C is approximately 1.81 inches or about 0.50 inches deeper than the low profile housing. However, this amount is significant. Since food product is often placed close to the door and the light source the width of the illumination can be significantly reduced leaving a dark area between shelf illumination patterns. An additional, 0.50 inches in distance results in a wider illumination pattern to eliminate or reduce dark areas according to the invention.

Advantageously, lighting assembly B is constructed from a plurality of lighting modules C either in the form of a master module or a slave module, as explained below. The modular lighting assembly construction allows the lighting system to be constructed in different lengths in a convenient and expeditious manner. In the illustrated embodiment, 15 LED light assemblies, each including a LED 36 and a lens 46, are provided in a five-foot lighting assembly strip. As can best be seen in FIG. 14, low profile C-channel housing 90 includes a lower groove 78 and an upper groove 80, respectively. Lens plates 40 are held in place by the upper grooves 80 and the LED substrates are held in place in lower groove 78. The lens plates and LED substrates include alignment nipples 42 and holes 44, respectively. A series of LEDs is arranged along the LED substrate 34 and a series of lenses 46 is arranged along the lens plate 40. Except for the modular construction to be disclosed in more detail below, the lens plate 40, the lenses 46 with exterior dome 56 and interior dome 54 are the same. The LED substrates 92 include master modules 94 and slave modules 96. As can best be seen in FIG. 14, the master modules 94 have a current control circuit 98 printed on the bottom of the substrate.

As can best be seen in FIGS. 11-13, illustrated modular lighting assembly B includes five LED lighting modules C. There are three master lighting modules 94 and two slave lighting modules 96 illustrated as a five foot lighting assembly. The modules are provided in one-foot lengths (11.4 inches). One slave assembly is associated and used with one master assembly due to the voltage drop across the modules based on the voltage required for each LED. For example, in the illustrated embodiment, each LED requires 3.5 volts or 21.5 volts for six lights in one master module and one slave module. Continuing the module in this manner in the illustrated embodiment allows use of a low voltage power supply 100 of 24 volts.

Modular lighting assembly B, includes a first master lighting assembly 94a, a first slave lighting assembly 96a, a second master lighting assembly 94b, a second slave lighting assembly 96b, and a third master lighting assembly 94c. This results in a standard five-foot lighting assembly B. Low voltage source 100 is connected to the light control circuit 98 of each master lighting module 94. Electrical conductors 102 and 104 connect the low voltage across the master and slave lighting modules, and conductors 106 and 108 connect the low voltage source to current control circuits 98. In turn, the current from the control circuits is delivered to LEDs 36 on the lighting modules via current delivery circuits 110. The current control and delivery circuits, and the conductors are preferably printed on the bottom substrate of the lighting modules and the associated master and slave modules are electrically wired together.

Power input to master lighting module 94a is input to current control circuit 98 which delivers a constant current to the LEDs 36 of master and slave modules 94a and 96a. At the same time, power is applied to current control circuit 98 of master lighting modules 94b and 94c via conductors 102 and 104. Master lighting module 94b delivers a constant current to the LEDs on master lighting module 94b and slave lighting module 96b. Master lighting module 94c only delivers current to the LEDs on master module 94c.

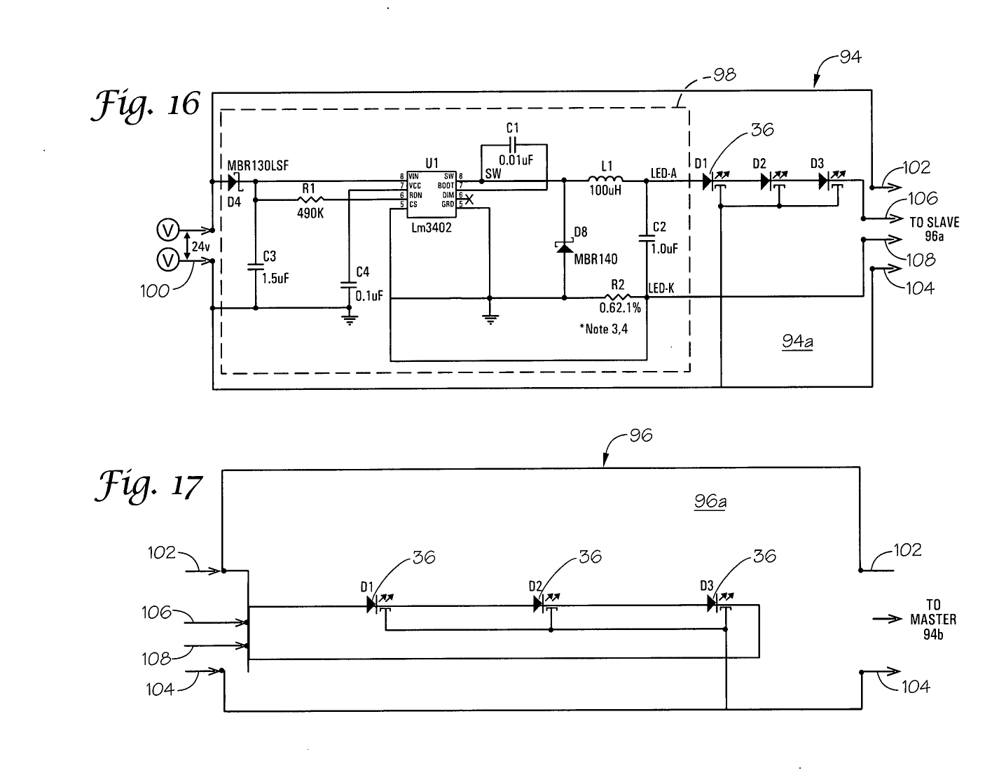

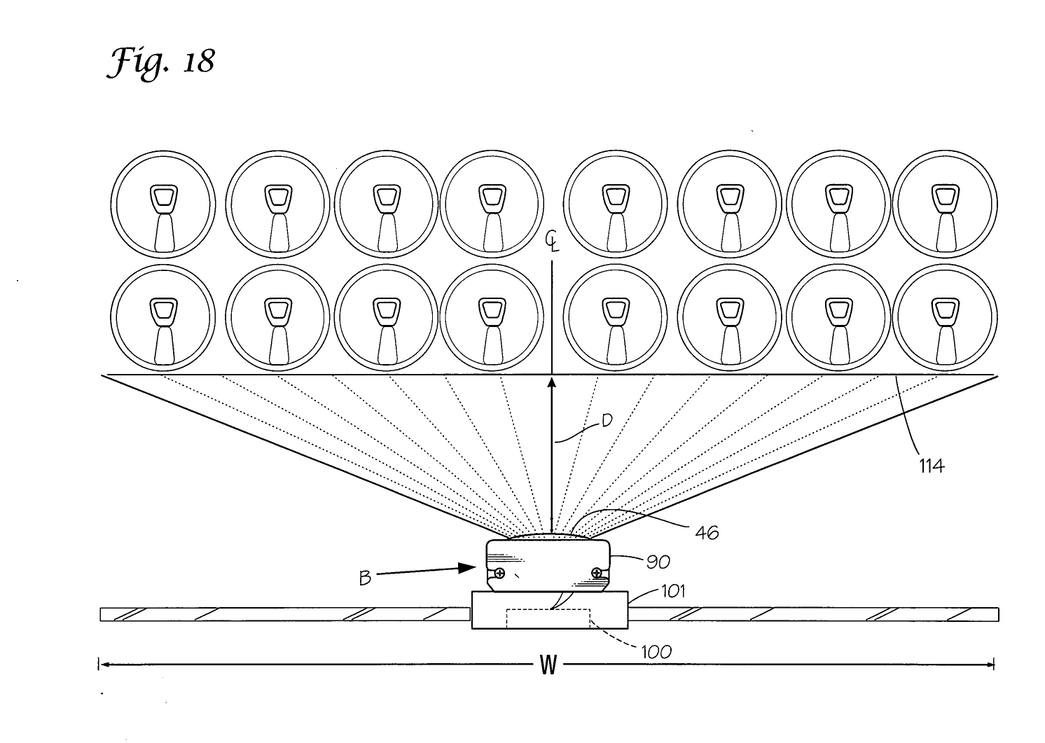

Referring to FIGS. 17 and 18, constant current control circuit 98, and master lighting modules C, 94 will be described in more detail. Master lighting modules 94 includes a current control circuit 98 imprinted on the bottom thereof by standard printing circuit techniques. The heart of the current control circuit is a LED driver chip U1 which converts the low voltage to a current source for LEDs 36, and makes adjustments to the output to ensure the LED driver current is constant despite variables and supply and load. Any suitable driver chip may be utilized, such as a LM3402 driver chip available from National Semiconductor. A capacitor C3 is connected across the power source to control the amount of power ripple that is induced to driver chip U1. A resistor R1 is connected to the drive chip to control the amount of on time of the MOSFET switch internal to the driver chip. A bypass capacitor C4 is connected to the drive chip as a bypass filter capacitor for the internal voltage regulation of driver chip U1. A diode D6 provides a path for the current supply by an inductor L1 when the MOSFET internal to the driver U1 is off. A storage capacitor C2 is used to dampen the output pulses to the LEDs 36 provided by inductor L1, and the inductor stores the current used to feed the string of LED lights 36. A current control resistor R2 determines the average current supplied to the string of LEDs 36 via the driver chip U1 and inductor L1 in accordance with its value. Finally, a diode D4 protects the circuit from reverse polarity at the connection of power supply source 100. Of course, other suitable constant current controllers may be used as within the purview of those skilled in the art.

As can best be seen in FIG. 18, illustrates low profile lighting assembly B disposed in front of a shelf 114, or other product containing structure, which has been found highly advantageous in providing uniform illumination of the product in front of the lighting assembly and behind the glass enclosure, particularly when the food is close to the LED light units 24 as in large walk-in coolers where product is pulled to the front of the cooler. Often, the product is placed at a perpendicular distance (D) of less than four inches, which reduces the illumination and darkens the cooler. Typically, the light assembly of the present invention provides a uniform illumination of the product at 14 inches on either side of the lighting assembly, i.e. a 28-inch total width (W) of uniform illumination. Preferably, the light assembly illuminates approximately one-half of the shelf width (14 inches) on either side of the center line of the light source. When the low profile lighting assembly B is used, the perpendicular distance may be effectively increased by approximately 0.50 inches spreading the illumination width if the produce is close.

The all-refractive lens assembly of the refrigerator strip light has been found to provide an efficiency of 90%, effectively illuminating a 60 inch tall by 28 inch wide product surface area from a range of 4 inches beyond the face of the lens. The lens assembly achieves plus or minus 25% luminance uniformity, in spite of the extreme aspect ratio presented by the product surface. The front face of the lens is a smooth, low profile nearly spherical surface that can be easily cleaned. The lens uses clear PMMA (acrylic) material, and can be produced using compression molding techniques.

The lighting system of the present invention is provided for use primarily within refrigerated cabinets such as that illustrated in FIG. 1. However, the lighting system described herein is suitable for a wide variety of other applications not listed herein. Although several embodiments have been described in some detail for purposes of illustration, various modifications may be made without departing from the scope and spirit of the invention. Accordingly, the invention is not limited to the embodiments provided herein. These illustrated examples are offered by way of illustration of the invention's versatility and not meant to limit the invention any way. The present invention may be embodied in other specific forms without departing from its spirit and essential characteristics. The described embodiments are to be considered in all respects only illustrative and not restrictive. The scope of the invention is, therefore, indicating by the appended claims, rather than by the foregoing description. All changes that come within a meaning and range of equivalency of the claims are embraced within their scope.

1. An LED lighting assembly for use in a refrigerated display cabinet and the like adapted for connection to a voltage source, said assembly comprising:
a longitudinal housing;
a plurality of LED lighting modules carried end-to-end to form a strip along a length of said housing;
a plurality of LEDs carried by said lighting modules;
a plurality of refractive lens carried by said housing covering said plurality of LEDs for dispersing a wide angle of light from each of the plurality of LEDs; and
a constant current control circuit carried by at least one of said lighting modules for delivering a generally constant electrical current to said LEDs.

2. The assembly of claim 1 wherein said LED lighting modules include at least one master lighting module and at least one slave lighting module associated with said master module, and said current control circuit being carried on said master lighting module and electrically connected to the LEDs on said master and slave lighting modules.

3. The assembly of claim 2 including a current delivery circuit carried by a master lighting module and an associated slave lighting module electrically connecting said current control circuit to the LEDs of said lighting modules.

4. The assembly of claim 2 including first electrical conductors for inputting a voltage to said current control circuit of each master lighting module in said housing, and second electrical conductors for applying the voltage across said master and associated slave lighting modules, and said second conductors are arranged in parallel with the first conductors so that the full voltage of said voltage source is input to said current control circuits of successive master modules in said housing.

5. The assembly of claim 2 wherein the number of said master lighting modules and slave lighting modules depends on the desired length of said lighting assembly, the current control circuit of each said master lighting module adapted for connection to the voltage source and being electrically connected with an associated slave lighting module so that the LEDs of said master and slave lighting modules are provided with a generally constant current, and wherein each slave lighting module is associated with a master lighting module.

6. The assembly of claim 5 wherein said voltage source is located remote from an interior of said housing of said lighting assembly.

7. The assembly of claim 1 wherein said voltage source is located outside of said light assembly housing so that a low profile housing can be had, said low profile housing allowing said lighting assembly to be utilized to effectively illuminate product with minimum space between the product and lighting assembly.

8. The assembly of claim 1 wherein said master and slave lighting modules include a substrate, and a plurality of heat sink holes formed in said substrate arranged to promote the flow of heated air away from one or more of said plurality of LEDs.

9. The assembly claim 8 wherein said heat sink holes include a plated-through metal lining in metal-to-metal contact with said metal heat sink.

10. The assembly of claim 9 wherein said housing includes an interior air space beneath said substrate.

11. The assembly of claim 10 wherein said air space is constructed and arranged to receive the heated air generated by one or more of said plurality of LEDs into said interior air space.

12. The assembly of claim 1 including a lens plate carried by said housing above said LED lighting modules, said lens including shaped lens having an interior dome and an exterior dome, said exterior dome extending outward from a first surface of said lens plate, said interior dome extending inward from a second surface towards said exterior dome, wherein said interior dome and said interior dome are cooperatively shaped to refract the light emitted from an LED into a wider angle of dispersion.

13. The lens of claim 12 comprising a lower edge of said interior dome projecting below said lens plate in contact with an upper surface of said lighting modules surrounding a LED so that the lens plate is spaced a prescribed distance above said surface.

14. The lens of claim 12 wherein said interior dome is cooperatively arranged with said lower edge to contain and disperse light from said LED.

15. The lens of claim 12 further comprising an alignment nipple extending from said lens plate for use in properly aligning said shaped lens above said LED.

16. A LED lighting assembly for use with a low voltage source in a refrigerated display cabinet, comprising:
a longitudinal housing;
a LED substrate carried by a housing, and a plurality of LEDs carried on said substrate;
a lens plate carried by said housing above said LED substrate including a plurality of shaped lens superposed above said LEDs;
a constant current control circuit carried by said LED substrate for delivering a generally constant electrical current to said LEDs wherein said current control circuit is adapted for connection to the low voltage source;
a current delivery circuit carried by a said LED substrate electrically connecting said current control circuit to the LEDs of said lighting modules.
first electrical conductors for inputting the low voltage to said current control circuit, and second electrical conductors arranged parallel to said first conductors for applying the voltage across said LED at successive arrangements of LEDs in said housing;
a metal heat sink disposed upon said LED substrate, wherein the heat generated by the plurality of LEDs is transferred to said metal heat sink.

17. The assembly of claim 16 wherein said rigid substrate comprises two conductors operatively connected to said LEDs and a power supply carried within said housing and operatively connected to said conductors for supplying power to said LEDs.

18. The assembly of claim 16 further comprising an alignment nipple receiving hole formed in said substrate for use in properly aligning a lens directly above each of said plurality of LEDs.

19. The assembly of claim 16 further comprising a plurality of heat sink holes formed in said LED substrate arranged to promote the flow of heated air away from one or more of said plurality of LEDs.

20. The assembly of claim 20 wherein said housing includes an interior air space beneath said substrate for receiving heated air generated by one or more of said plurality of LEDs into said interior air space.

21. The assembly of claim 16 wherein said shaped lens includes a lower edge projecting below a lower surface of said lens plate and contacting an upper surface of said LED substrate to define a prescribed uniform space between the lens and the LED.

22. The assembly of claim 16 wherein said shaped lens includes an interior dome and an exterior dome, said exterior dome extending outward from a first surface of said lens plate, said interior dome extending inward from a second surface towards said exterior dome, wherein said interior dome and said interior dome are cooperatively shaped to refract the light emitted from an LED into a wider angle of dispersion.

23. A method of constructing an elongated LED lighting assembly having an elongated housing comprising:
arranging a plurality of LED lighting modules end-to-end along a length of said elongated housing;
arranging said lighting modules to include one or more master lighting modules wherein each is followed by at least one associated slave lighting module wherein the master lighting module includes a current control circuit for delivering current to the LEDs on the master lighting module and the associated slave lighting module;
providing a voltage source outside of said elongated housing for applying a voltage to the input of the master lighting modules successively along the length of said elongated housing; and
dispersing light from said illuminated LEDs by covering each LED with a shaped refractive lens.

24. The method of claim 23 including removing heat from the illuminated LEDs by providing heat sink holes arranged in a substrate of said lighting modules so that the heat flows into an interior air space below the said substrates.

25. The method of claim 23 comprising providing said elongated housing as a low profile housing containing said master and slave lighting modules with said shaped lens carried on a lens plate superimposed above said lighting modules.

26. The method of claim 23 including forming said lighting assembly in a pre-determined length by selecting the number of master and slave lighting modules to be included in said housing when said lighting modules are connected by conductors end-to-end.
